(19) United States
(12) Patent Application Publication
(10) Pub. No.: US 2024/0420470 A1
(43) Pub. Date: Dec. 19, 2024

(54) AUTOMATIC MACHINE CONFIGURATION BASED UPON HUMAN ACTIVITY IN A WORKSPACE ENVIRONMENT

(71) Applicant: International Business Machines Corporation, Armonk, NY (US)

(72) Inventors: Tushar Agrawal, West Fargo, ND (US); ChunHui Y. Higgins, Raleigh, NC (US); Pengxiang Xu, Huntington Beach, CA (US); Sarbajit K. Rakshit, Kolkata (IN)

(21) Appl. No.: 18/209,404

(22) Filed: Jun. 13, 2023

(51) Int. Cl. G06V 20/52; G06T 7/80; G06V 10/82; G06V 20/70; G10L 21/0208

(52) U.S. Cl. CPC G06V 20/52; G06T 7/80; G06V 10/82; G06V 20/70; G10L 21/0208; G06T 2207/20081; G06T 2207/30196; G06V 2201/07

(57) ABSTRACT

Techniques are described with regard to automatic machine configuration in a workspace environment. An associated computer-implemented method includes collecting workspace activity data in a workspace environment including at least one machine, wherein the workspace activity data is collected at least in part via a plurality of video frames captured by a plurality of video cameras and via a plurality of audio segments captured by at least one microphone. The method further includes configuring at least one workspace positioning artificial neural network based upon analysis of the workspace activity data, applying the at least one workspace positioning artificial neural network to derive at least one human activity datapoint in the workspace environment, and automatically configuring the at least one machine based upon the at least one human activity datapoint.

### BACKGROUND

The various embodiments described herein generally relate to workspace configuration. More specifically, the various embodiments relate to machine configuration in a workspace environment.

### SUMMARY

The various embodiments described herein provide techniques associated with workspace configuration. An associated computer-implemented method includes collecting workspace activity data in a workspace environment including at least one machine, where the workspace activity data is collected at least in part via a plurality of video frames captured by a plurality of video cameras and via a plurality of audio segments captured by at least one microphone. The method additionally includes configuring at least one workspace positioning artificial neural network based upon analysis of the workspace activity data. The method further includes applying the at least one workspace positioning artificial neural network to derive at least one human activity datapoint in the workspace environment. The method further includes automatically configuring the at least one machine based upon the at least one human activity datapoint.

One or more additional embodiments pertain to a computer program product including a computer readable storage medium having program instructions embodied therewith. According to such embodiment(s), the program instructions are executable by a computing device to cause the computing device to perform one or more steps of and/or to implement one or more embodiments associated with the above recited computer-implemented method. One or more further embodiments pertain to a system having at least one processor and a memory storing an application program, which, when executed on the at least one processor, performs one or more steps of and/or implements one or more embodiments associated with the above recited computer-implemented method.

### BRIEF DESCRIPTION OF THE DRAWINGS

So that the manner in which the above recited aspects are attained and can be understood in detail, a more particular description of embodiments, briefly summarized above, may be had by reference to the appended drawings. Note, however, that the appended drawings illustrate only typical embodiments of the invention and therefore are not to be considered limiting of its scope, for the invention may admit to other equally effective embodiments.

FIG. 1 illustrates a computing infrastructure, according to one or more embodiments.

FIG. 2 illustrates a workspace configuration application in a computing infrastructure, according to one or more embodiments.

FIG. 3 illustrates an example diagram of a workspace environment, according to one or more embodiments.

FIG. 4 illustrates a method of automatically configuring at least one machine based upon human activity in a workspace environment.

FIG. 5 illustrates a method of collecting workspace activity data in a workspace environment, according to one or more embodiments.

FIG. 6 illustrates a method of configuring at least one workspace positioning artificial neural network based upon analysis of workspace activity data, according to one or more embodiments.

FIG. 7 illustrates a method of configuring a video-based human frame presence recognition artificial neural network, according to one or more embodiments.

FIG. 8 illustrates a method of configuring at least one workspace positioning artificial neural network based upon analysis of workspace activity data, according to one or more further embodiments.

FIG. 9 illustrates a method of configuring a video-based human zone presence recognition artificial neural network, according to one or more embodiments.

FIG. 10 illustrates a method of configuring at least one workspace positioning artificial neural network based upon analysis of workspace activity data, according to one or more further embodiments.

FIG. 11 illustrates a method of configuring an audio-based human zone presence recognition artificial neural network, according to one or more embodiments.

FIG. 12 illustrates a method of configuring an audio-based human location prediction artificial neural network, according to one or more embodiments.

FIG. 13 illustrates a method of automatically configuring at least one machine based upon at least one human activity datapoint, according to one or more embodiments.

### DETAILED DESCRIPTION

The various embodiments described herein are directed to automatically configuring at least one machine based upon human activity in a workspace environment. The various embodiments facilitate machine configuration responsive to analysis of human workspace activity via at least one workspace positioning artificial neural network.

The various embodiments described herein have advantages over conventional techniques. The various embodiments facilitate safe and efficient human-machine interaction in a workspace environment. The various embodiments improve computer technology by enabling automatic configuration of machine activity based upon derivation of at least one human activity datapoint consequent to application of at least one workspace positioning artificial neural network. Such automatic configuration may include facilitating adjustment of machine operation mode and/or facilitating machine maintenance in the workspace environment. Some of the various embodiments may not include all such advantages, and such advantages are not necessarily required of all embodiments.

In the following, reference is made to various embodiments of the invention. However, it should be understood that the invention is not limited to specific described embodiments. Instead, any combination of the following features and elements, whether related to different embodiments or not, is contemplated to implement and practice the invention. Furthermore, although embodiments may achieve advantages over other possible solutions and/or over the prior art, whether or not a particular advantage is achieved by a given embodiment is not limiting. Thus, the following aspects, features, embodiments, and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in one or more claims.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given computer program product claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data typically is moved at some occasional points in time during normal operations of a storage device, such as during access, de-fragmentation, or garbage collection, but this does not render the storage device as transitory because the data is not transitory while it is stored.

Particular embodiments describe techniques relating to workspace configuration. However, it is to be understood that the techniques described herein may be adapted to a variety of purposes in addition to those specifically described herein. Accordingly, references to specific embodiments are included to be illustrative and not limiting.

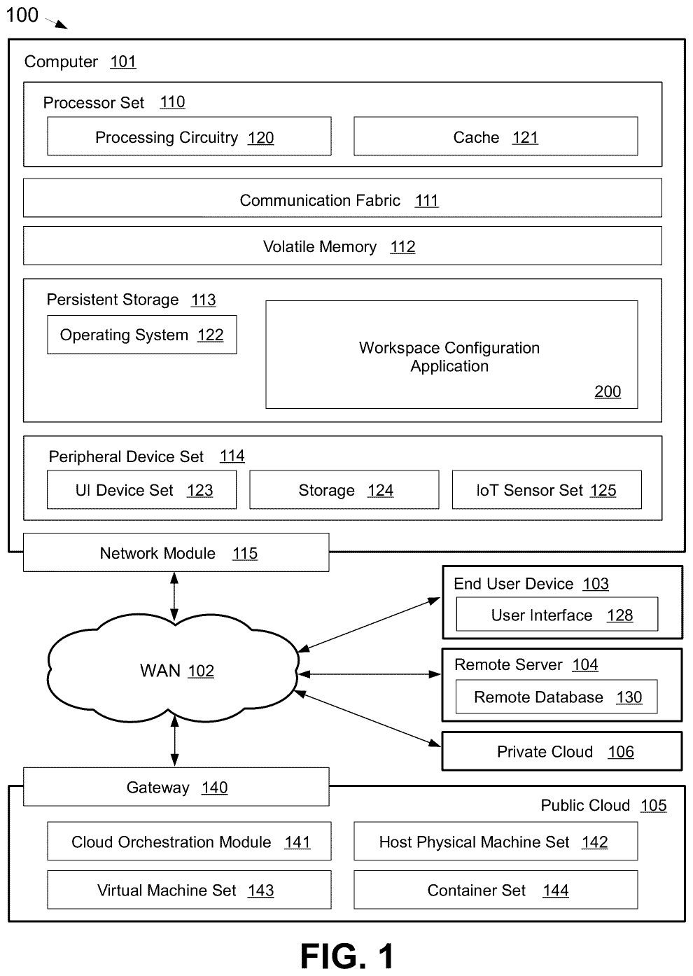

With regard to FIG. 1, computing environment 100 includes an example of an environment for the execution of at least some of the computer code involved in performing the inventive methods, such as code included in or otherwise associated with workspace configuration application 200. In addition to workspace configuration application 200, computing environment 100 includes, for example, computer 101, wide area network (WAN) 102, end user device (EUD) 103, remote server 104, public cloud 105, and private cloud 106. As depicted in FIG. 1, computer 101 includes processor set 110, communication fabric 111, volatile memory 112, persistent storage 113, peripheral device set 114, and network module 115. Processor set 110 includes processing circuitry 120 and cache 121. Persistent storage 113 includes operating system 122 and workspace configuration application 200, as identified above. Peripheral device set 114 includes user interface (UI) device set 123, storage 124, and Internet of Things (IoT) sensor set 125. EUD 103 includes user interface 128. User interface 128 is representative of a single user interface or multiple user interfaces. Remote server 104 includes remote database 130. Remote database 130 is representative of a single remote database or multiple remote databases. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network, or querying a database, such as remote database 130. Computer 101 is included to be representative of a single computer or multiple computers. As is well understood in the art of computer technology, and depending upon the technology, performance of a computer-implemented method may be distributed among multiple computers and/or between multiple locations. As depicted in FIG. 1, detailed discussion is focused on a single computer, specifically computer 101, to keep the presentation of computing environment 100 as simple as possible. Additionally or alternatively to being connectively coupled to public cloud 105 and private cloud 106, computer 101 may be located in a cloud, even though it is not shown in a cloud in FIG. 1. On the other hand, computer 101 is not required to be in a cloud or connectively coupled to a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories typically are organized into multiple levels depending upon relative proximity to the processing circuitry. Alternatively, some, or all, of the cache 121 for processor set 110 may be located “off chip”. In some computing environments, processor set 110 may be designed for working with qubits and performing quantum computing.

Computer readable program instructions typically are loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions and associated data are accessed by processor set 110 to control and direct performance of the inventive methods. In computing environment 100, at least some of the instructions for performing the inventive methods may be stored in workspace configuration application 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but additionally or alternatively volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and rewriting of data. Persistent storage 113 may include magnetic disks and/or solid state storage devices. Operating system 122 may take several forms, such as various known proprietary operating systems or open source Portable Operating System Interface-type operating systems that employ a kernel. Workspace configuration application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (e.g., secure digital (SD) card), connections made through local area communication networks, and even connections made through wide area networks such as the Internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), such storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor among IoT sensor set 125 may be a thermometer, and another sensor may be a motion detector.

Network module 115 is the collection of computer software, hardware, and firmware that allows computer 101 to communicate with other computers through WAN 102. Network module 115 may include hardware such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments, e.g., embodiments that utilize software-defined networking (SDN), the control functions and the forwarding functions of network module 115 are performed on physically separate devices, such that the control functions manage several different network hardware devices. Computer readable program instructions for performing the inventive methods typically can be downloaded to computer 101 from an external computer or external storage device through a network adapter card or network interface included in network module 115.

Wide area network (WAN) 102 is any wide area network, e.g., the Internet, capable of communicating computer data over non-local distances by any technology for communicating computer data, now known or to be developed in the future. In some embodiments, WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

End user device (EUD) 103 is any computer system that is used and controlled by an end user, e.g., a customer of an enterprise that operates computer 101. EUD 103 may take any of the forms previously discussed in connection with computer 101. EUD 103 typically receives helpful and useful data from the operations of computer 101. For example, in a hypothetical case where computer 101 is designed to provide information to an end user, such information typically would be communicated from network module 115 of computer 101 through WAN 102 to EUD 103. In this way, EUD 103 can display, or otherwise present, the recommendation to an end user, e.g., via user interface 128. In another example, in a hypothetical case where computer 101 is designed to provide configuration information to user interface 128, e.g., via workspace configuration application 200, such configuration information typically would be communicated from network module 115 of computer 101 through WAN 102 to EUD 103. In some embodiments, EUD 103 may be a client device, such as thin client, heavy client, mainframe computer, desktop computer, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data (e.g., user history data), such historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. Public cloud 105 optionally offers infrastructure as a service (IaaS), platform as a service (PaaS), software as a service (SaaS), and/or other cloud computing services. The computing resources provided by public cloud 105 typically are implemented by virtual computing environments (VCEs) that run on various computers making up the computers of host physical machine set 142, which is the universe of physical computers in and/or available to public cloud 105. The VCEs typically take the form of virtual machines from virtual machine set 143 and/or containers from container set 144. It is understood that such VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Further explanation of VCEs now will be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the perspective of programs running in them. A computer program running on an ordinary operating system can utilize all resources of that computer, such as connected devices, files and folders, network shares, central processing unit (CPU) power, and quantifiable hardware capabilities. However, programs running inside a container only can use the contents of the container and devices assigned to the container, a feature which is known as containerization.

Private cloud 106 is similar to public cloud 105, except that the computing resources only are available for use by a single enterprise. While private cloud 106 is depicted in FIG. 1 as being in communication with WAN 102, in other embodiments a private cloud optionally is disconnected from the Internet or other public network entirely and is accessible only through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 both are part of a larger hybrid cloud.

In the context of the various embodiments described herein, components of computing environment 100, including aspects of workspace configuration application 200, provide, or are configured to provide, any entity associated with workspace configuration, e.g., any entity associated with computer 101, EUD 103, or another aspect of computing environment 100, advance notice of any personal data collection. Components of computing environment 100 further provide, or further are configured to provide, any affected entity an option to opt in or opt out of any such personal data collection at any time. Optionally, components of computing environment 100 further transmit, or further are configured to transmit, notification(s) to any affected entity each time any such personal data collection occurs and/or at designated time intervals.

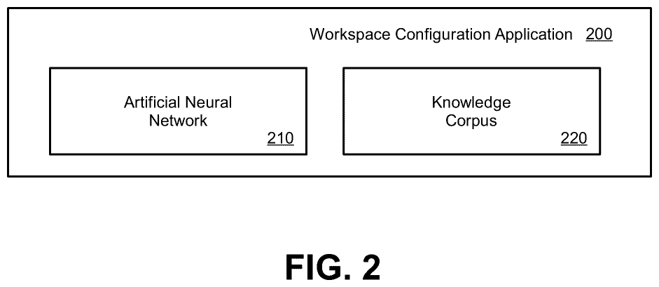

FIG. 2 illustrates an example diagram of workspace configuration application 200. Workspace configuration application 200 includes workspace positioning artificial neural network 210 and knowledge corpus 220. Workspace positioning artificial neural network 210 is representative of a single workspace positioning artificial neural network or multiple workspace positioning artificial neural networks. Knowledge corpus 220 includes workspace activity data and any classification data associated with workspace activity. Workspace positioning artificial neural network 210 stores data to and receives data from knowledge corpus 220.

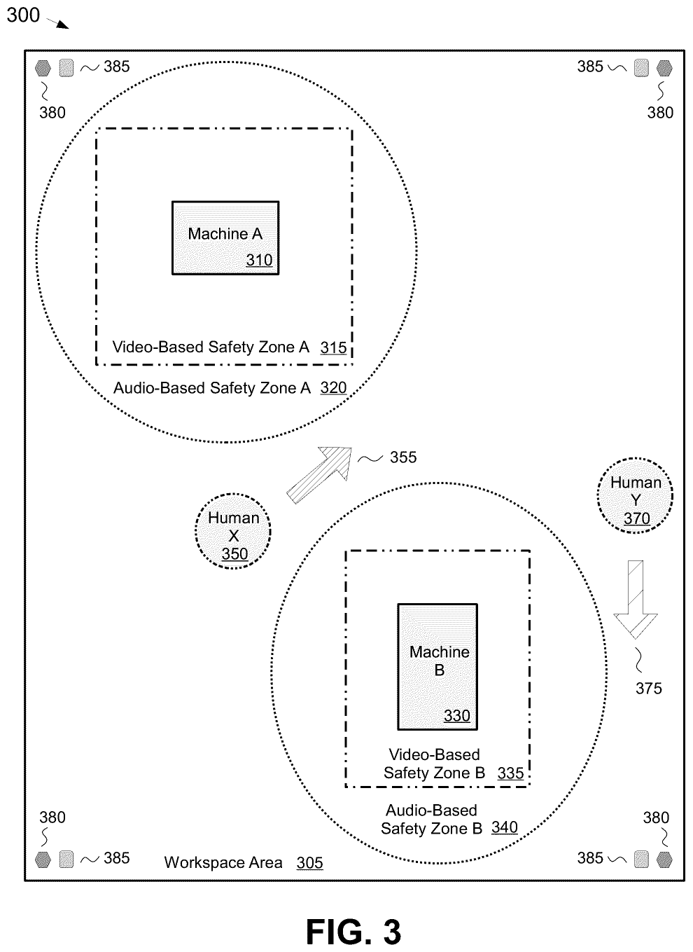

FIG. 3 illustrates an example diagram of a workspace environment 300. The diagram provides an overhead perspective of workspace environment 300. Workspace area 305 of workspace environment 300 as illustrated is provided as an example and is not intended to be limiting in terms of shape, size, and/or configuration. Workspace area 305 includes Machine A 310, video-based safety zone A 315 associated with Machine A 310, and audio-based safety zone A 320 associated with Machine A 310. Workspace area 305 includes Machine B 330, video-based safety zone B 335 associated with Machine B 330, and audio-based safety zone B 340 associated with Machine B 330. While two machines are depicted in FIG. 3, a workspace environment as contemplated by the various embodiments may include a different quantity of machines. While video-based safety zone A 315 and video-based safety zone B 335 are depicted as rectangular in shape, a video-based safety zone as contemplated by the various embodiments may be of an alternative shape. While audio-based safety zone A 320 and audio-based safety zone B 340 are depicted as circular in shape, an audio-based safety zone as contemplated by the various embodiments may be of an alternative shape. Workspace area 305 includes Human X 350 and Human Y 370. Human X 350 and/or Human Y 370 may be associated with at least one human wearable device. Arrow 355 associated with Human X 350 and arrow 375 associated with Human Y 370 depict respective potential human traversal path directions in workspace area 305 in view of the respective depicted safety zones. Arrow 355 indicates a potential direction of traversal and is not intended to indicate a sole direction of traversal. Arrow 375 indicates a potential direction of traversal and is not intended to indicate a sole direction of traversal. While two humans are depicted in FIG. 3 as an example, a workspace environment as contemplated by the various embodiments may include a different quantity of humans. Workspace environment 300 further includes video cameras 380 and microphones 385. While four video cameras and four microphones are depicted in FIG. 3 as an example, a workspace environment as contemplated by the various embodiments may include a different quantity of video cameras, e.g., one or more video cameras, and further may include a different quantity of microphones, e.g., one or more video cameras. Additionally, while the four video cameras and four microphones depicted in FIG. 3 are located in respective corners of workspace area 305 as an example, a workspace environment as contemplated by the various embodiments may include video camera(s) and/or microphone(s) in any combination in any mountable location(s) throughout workspace area 305 or external to but within visual/audio range of workspace area 305. Furthermore, a workspace environment as contemplated by the various embodiments may include video camera(s) and/or microphone(s) in any combination in respective configurations adjacent to machine(s) and/or human(s) in workspace area 305. Video cameras 380 and microphones 385 may incorporate or otherwise interact with sensors configured to detect workspace activity. As further described herein, workspace configuration application 200 is configured to analyze activity within or otherwise associated with workspace environment 300 and is further configured to facilitate machine configuration, including machine operation adjustment and/or machine maintenance, in workspace environment 300 based upon such analysis.

Aspects of computing environment 100 optionally are located in workspace environment 300 or alternatively are communicatively coupled to respective elements of workspace environment 300 through network-based communication, e.g., via WAN 102. In an embodiment, workspace configuration application 200 is communicatively coupled to at least one of Machine A 310 and Machine B 330. In an additional embodiment, workspace configuration application 200 is communicatively coupled to all or a subset of video cameras 380 and microphones 385.

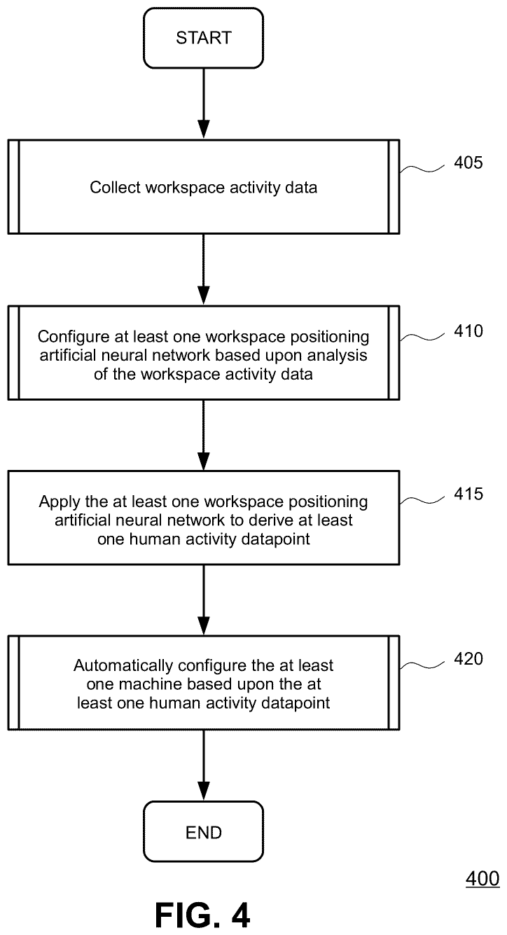

FIG. 4 illustrates a method 400 of automatic machine configuration in a workspace environment. One or more steps associated with the method 400 and related methods described herein optionally are carried out via a workspace configuration application in a computing environment (e.g., via workspace configuration application 200 included in computer 101 of computing environment 100). One or more steps associated with the method 400 and related methods described herein optionally are carried out within, or in association with, one or more workloads of a cloud computing environment. Such cloud computing environment optionally includes a public cloud (e.g., public cloud 105) and/or a private cloud (e.g., private cloud 106).

The method 400 begins at step 405, where the workspace configuration application collects workspace activity data in a workspace environment including at least one machine (e.g., workspace environment 300 including Machine A 310 and Machine B 330). The workspace configuration application collects the workspace activity data at least in part based upon activity within a workspace area of the workspace environment (e.g., workspace area 305). The workspace configuration application collects the workspace activity data at least in part via a plurality of video frames captured by a plurality of video cameras (e.g., a plurality of video cameras among video cameras 380) and via a plurality of audio segments captured by at least one microphone (e.g., at least one microphone among microphones 385). In an additional embodiment, the workspace configuration application collects workspace activity data associated with human activity and/or machine activity in the workspace environment. In a further embodiment, the at least one machine included in the workspace environment has automation capabilities and/or human enhancement capabilities. In a further embodiment, the at least one machine optionally includes at least one physical attribute configured to perform at least one task in the workspace environment. In a further embodiment, the workspace environment is an industrial environment, e.g., a factory floor. In a further embodiment, the workspace environment is a commercial environment, e.g., associated with an incorporated entity such as a business or governmental organization. In a further embodiment, the workspace environment is a healthcare environment, e.g., associated with a medical facility or an assisted care facility. In a further embodiment, the workspace environment is a machine-enhanced residential environment, e.g., associated with a hotel, a condominium, an apartment, etc.

In an embodiment, the workspace configuration application collects certain aspects of the workspace activity data from a plurality of sensors. In a related embodiment, the plurality of sensors detect operational parameters associated with the at least one machine. According to such embodiment, the workspace configuration application incorporates detected operational parameters and information related thereto into the workspace activity data. In an additional embodiment, the workspace activity data includes machine activity data pertaining to activity-specific information associated with one or more of the at least one machine in the workspace environment. In a further embodiment, the plurality of sensors detect parameters associated with at least one human in the workspace environment, e.g., parameters associated with human voice and/or human movement in the workspace environment. In a further embodiment, the plurality of sensors are incorporated into at least one audiovisual tool, such as the plurality of video cameras and/or the at least one microphone.

In an embodiment, the plurality of video cameras are positioned in the workspace environment or within visual range of the workspace environment. The plurality of video cameras are installed to capture video (and optionally audio) associated with at least one location in the workspace environment. Video camera sensors and/or lens of each of the plurality of video cameras are configured to capture audiovisual aspects associated with the at least one location, including video (and optionally audio) of human activities and/or machine activities performed at or near the at least one location. In a related embodiment, the workspace configuration application obtains and processes data from the plurality of video cameras in order to derive composite image data associated with multiple views of a machine among the at least one machine. The composite image data optionally includes image depth data and data associated with multiple angular views of a machine among the at least one machine (e.g., a top machine view, a positive side machine view, a negative side machine view, and/or a bottom machine view). Optionally, the workspace configuration application obtains and processes video aspects based upon video captured adjacent to, or in a defined vicinity of, a machine among the at least one machine. As further described herein, the defined vicinity of a machine among the at least one machine in the context of video aspects is identified based upon a video-based safety zone associated with the machine (e.g., video-based safety zone A 315 or video-based safety zone B 335). The workspace configuration application incorporates the plurality of video frames captured by the plurality of video cameras and composite image data derived from the captured video aspects into video portions of the workspace activity data.

In an embodiment, the at least one microphone is positioned in the workspace environment or within audio range of the workspace environment. The at least one microphone is installed to capture audio aspects associated with at least one location in the workspace environment. In a related embodiment, the workspace configuration application obtains and processes audio aspects based upon voice and/or sound detected adjacent to, or in a defined vicinity of, a machine among the at least one machine. As further described herein, the defined vicinity of a machine among the at least one machine in the context of audio aspects is identified based upon an audio-based safety zone associated with the machine (e.g., audio-based safety zone A 320 or audio-based safety zone B 340). The workspace configuration application incorporates the plurality of audio segments captured by the at least one microphone into audio portions of the workspace activity data.

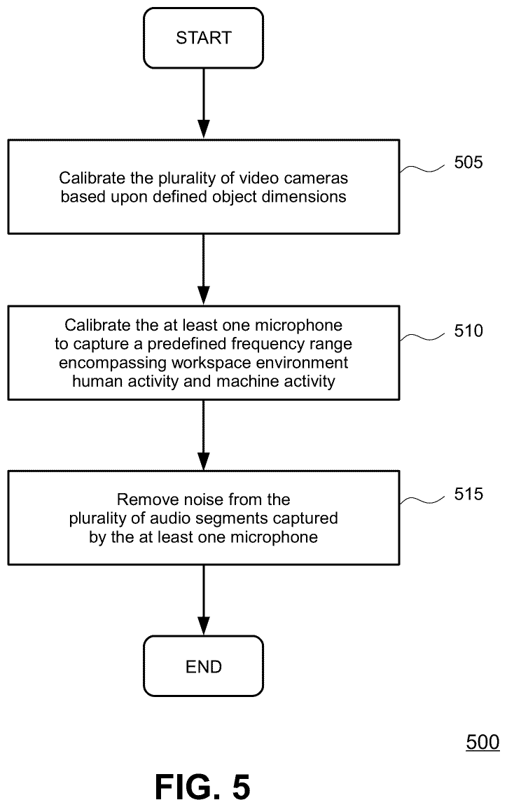

In an embodiment, the workspace configuration application obtains or receives at least one machine activity feed from one or more of the at least one machine. The at least one machine activity feed tracks at least one datapoint associated with machine functionality. In a related embodiment, the workspace configuration application collects some or all aspects of the at least one machine activity feed via one or more of the plurality of sensors previously described. In an additional embodiment, the workspace configuration application obtains or receives at least one human activity feed from at least one human located in the workspace environment or otherwise associated with the workspace environment. The at least one human activity feed enables the workspace configuration application to track human activity in the workspace environment or human activity otherwise associated with the workspace environment. In a related embodiment, the workspace configuration application obtains or receives all or a portion of the at least one human activity feed from at least one human wearable device configured to collect human movement information or biometric information associated with human identification and/or human activity. In a further related embodiment, the workspace configuration application collects some or all aspects of the at least one human activity feed via one or more of the plurality of sensors previously described. A method of collecting the workspace activity data in the workspace environment in accordance with step 405 is described with respect to FIG. 5.

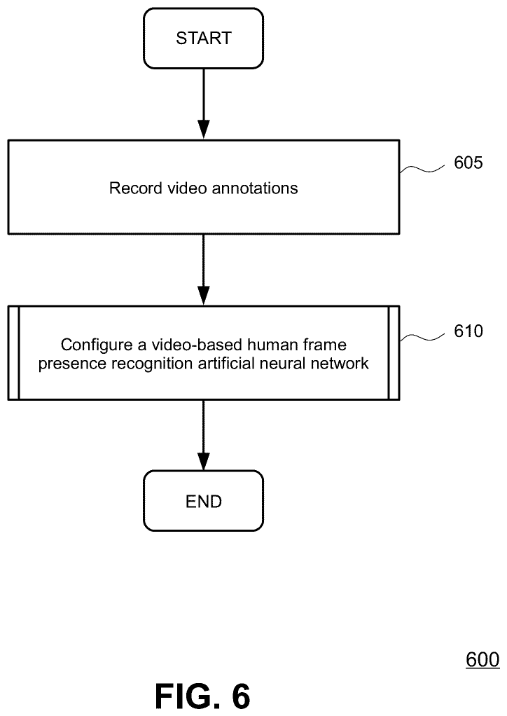

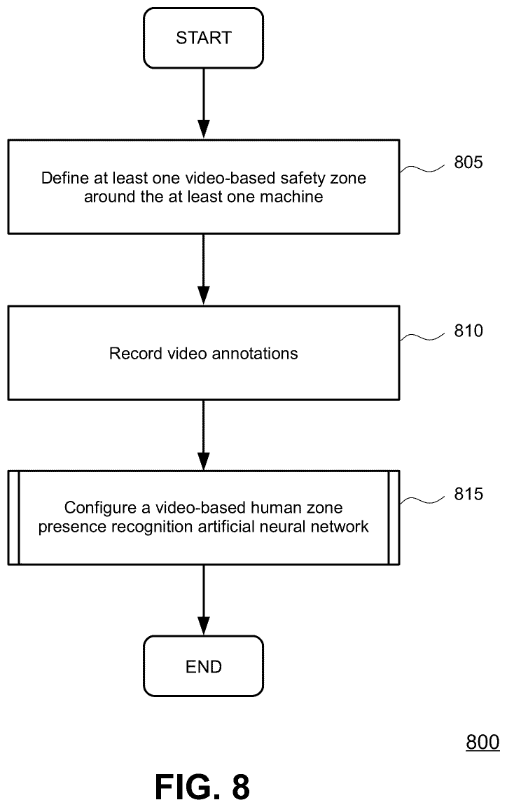

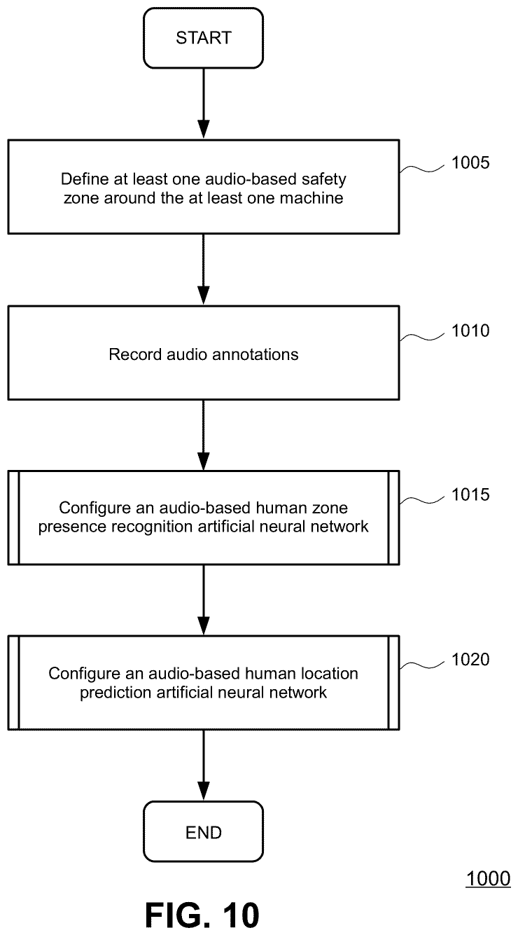

At step 410, the workspace configuration application configures at least one workspace positioning artificial neural network (e.g., workspace positioning artificial neural network 210) based upon analysis of the workspace activity data. Each of the at least one workspace positioning artificial neural network includes or is otherwise associated with at least one machine learning knowledge model configured for workspace positioning. By configuring the at least one workspace positioning artificial neural network per step 410, the workspace configuration application builds and updates a knowledge corpus (e.g., knowledge corpus 220) based upon organizing the workspace activity data and classifying human presence in association with the workspace environment. In an embodiment, the at least one workspace positioning artificial neural network includes a video-based human frame presence recognition artificial neural network configured to recognize human presence within one or more of the plurality of video frames incorporated into video portions of the workspace activity data. In an additional embodiment, the at least one workspace positioning artificial neural network includes a video-based human zone presence recognition artificial neural network configured to detect and analyze human presence (including human positioning and/or human movement) within at least one video-based safety zone. In a further embodiment, the at least one workspace positioning artificial neural network includes an audio-based human zone presence recognition artificial neural network configured to determine whether a human is present within at least one audio-based safety zone. In a further embodiment, the at least one workspace positioning artificial neural network includes an audio-based human location prediction artificial neural network configured to predict future human location and/or human movement in the workspace environment relative to the at least one audio-based safety zone. Methods of configuring the at least one workspace positioning artificial neural network based upon analysis of the workspace activity data in accordance with step 410 are described with respect to FIG. 6 (addressing configuration of a video-based human frame presence recognition artificial neural network), FIG. 8 (addressing configuration of a video-based human zone presence recognition artificial neural network), and FIG. 10 (addressing configuration of an audio-based human zone presence recognition artificial neural network and configuration of an audio-based human location prediction artificial neural network).

At step 415, the workspace configuration application applies the at least one workspace positioning artificial neural network to derive at least one human activity datapoint in the workspace environment. In an embodiment, the at least one human activity datapoint includes at least one real time observation associated with human activity in the workspace environment. In an additional embodiment, the at least one human activity datapoint is associated with at least one human presence observation or prediction associated with the workspace environment. In a related embodiment, the workspace configuration application applies the at least one workspace positioning artificial neural network in order to classify human presence within a video frame and identify a location of human activity in the workspace environment. According to such related embodiment, the workspace configuration application applies a video-based human frame presence recognition artificial neural network to a video frame among the plurality of video frames in order to classify the video frame as indicative of human presence or as indicative of no human presence (i.e., indicative of human absence). According to such related embodiment, the workspace configuration application associates a human frame presence classification result to a video camera among the plurality of video cameras associated with the video frame, e.g., based upon video camera identification number. According to such related embodiment, responsive to determining that the video frame of the video camera is classified as having human presence, the workspace configuration application calculates a three-dimensional location of a human in the workspace environment based upon location projection with respect to the video frame. Responsive to detecting multiple humans within the video frame of the video camera, the workspace configuration application calculates respective three-dimensional locations of each of the multiple humans in the workspace environment based upon location projection with respect to the video frame. In an additional related embodiment, the workspace configuration application applies the at least one workspace positioning artificial neural network in order to classify human presence within a video-based safety zone among the at least one video-based safety zone. According to such additional related embodiment, the workspace configuration application applies a video-based human zone presence recognition artificial neural network to classify a video frame among the plurality of video frames as indicative of human presence within the at least one video-based safety zone or as indicative of no human presence within the at least one video-based safety zone (i.e., indicative of human absence within the at least one video-based safety zone). In a further related embodiment, the workspace configuration application applies the at least one workspace positioning artificial neural network in order to classify human presence within an audio-based safety zone among the at least one audio-based safety zone. According to such further related embodiment, the workspace configuration application applies an audio-based human zone presence recognition artificial neural network to classify a textual word vector transcribed and tokenized from an audio segment among the plurality of audio segments as indicative of human presence within the at least one audio-based safety zone or as indicative of no human presence within the at least one audio-based safety zone (i.e., indicative of human absence within the at least one audio-based safety zone). In a further related embodiment, the workspace configuration application applies the at least one workspace positioning artificial neural network in order to project a human activity location, specifically human presence relative to the at least one audio-based safety zone, in the workspace environment at a future designated time (e.g., at x minutes and y seconds from present time). According to such further related embodiment, the workspace configuration application applies an audio-based human location prediction artificial neural network in order to classify a textual word vector transcribed and tokenized from an audio segment among the plurality of audio segments as indicative of human presence inside the at least one audio-based safety zone (i.e., within the at least one audio-based safety zone) at the future designated time or as indicative of human presence outside the at least one audio-based safety zone (i.e., not within the at least one audio-based safety zone) at the future designated time.

In an embodiment, the at least one human activity datapoint is associated with a human traversal path. In a related embodiment, the workspace configuration application projects a human traversal path based upon human presence classification relative to one or more of the at least one video-based safety-zone. In an additional related embodiment, the workspace configuration application projects a human traversal path based upon human presence classification relative to one or more of the at least one audio-based safety zone. In a further related embodiment, the workspace configuration application applies at least one kinematics equation in order to project a human traversal path in the workspace environment. The workspace configuration application applies the at least one kinematics equation in conjunction with application of the at least one workspace positioning artificial neural network (e.g., in conjunction with application of the video-based human zone presence recognition artificial neural network) or as an alternative to application of the at least one workspace positioning artificial neural network. According to such further related embodiment, the workspace configuration application records human location coordinates based upon a predefined series of video frames among the plurality of video frames captured within a designated duration. According to such further related embodiment, the workspace configuration application derives human movement parameters based upon the recorded human location coordinates. The human movement parameters include human velocity, human displacement, and/or human acceleration. According to such further related embodiment, the workspace configuration application projects a human traversal path based upon applying the at least one kinematics equation to the human movement parameters.

In an embodiment, in addition to or as an alternative to applying the at least one workspace positioning artificial neural network per step 415, the workspace configuration application identifies a location of human activity in the workspace environment based upon at least one human activity feed. In a related embodiment, the workspace configuration application identifies a location of human activity in the workspace environment based upon any detected wearable device parameter, e.g., any detected human movement parameter or any detected biometric parameter, associated with at least one human located in the workspace environment or otherwise associated with the workspace environment.

At step 420, the workspace configuration application automatically configures the at least one machine based upon the at least one human activity datapoint. According to step 420, the workspace configuration application automatically configures one or more machines along a human traversal path projected based upon applying the at least one workspace positioning artificial neural network and/or based upon applying at least one kinematics equation per step 415. In an embodiment, responsive to determining that a human is within a video-based safety zone or an audio-based safety zone associated with a machine among the at least one machine, the workspace configuration application transmits a command, e.g., via at least one control signal, to the machine to prompt an operation mode adjustment, e.g., a switch to a safety operation mode. In a related embodiment, the workspace configuration application determines at least one operating parameter associated with the machine and/or activity associated with the machine upon switching to a safety operation mode. In an additional embodiment, responsive to determining that a human is within a video-based safety zone or an audio-based safety zone associated with a machine among the at least one machine, the workspace configuration application facilitates movement of the machine to a designated maintenance area of the workspace environment. In a related embodiment, the workspace configuration application facilitates movement of the machine to a designated maintenance area by facilitating movement of a section of the workspace environment including the machine to the designated maintenance area, e.g., by facilitating movement of a moveable machine platform upon which the machine is mounted to the designated maintenance area. In a further related embodiment, responsive to determining that the machine is mobile, the workspace configuration application facilitates movement of the machine to a designated maintenance area by transmitting a command, e.g., via at least one control signal, to the machine to move to the designated maintenance area.

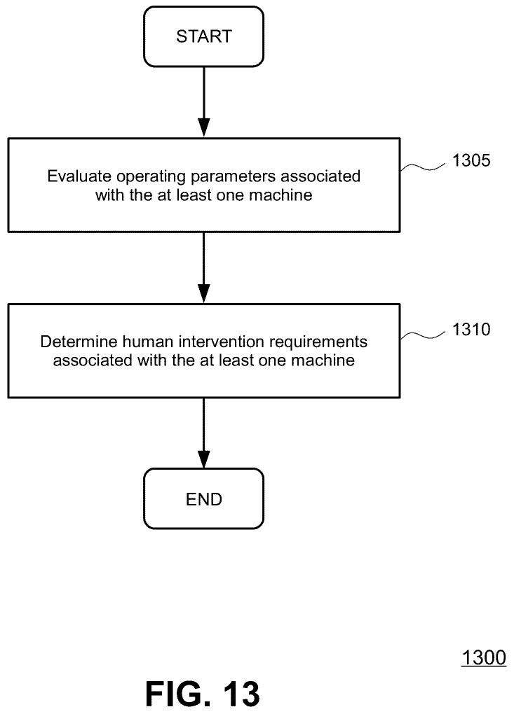

In an embodiment, responsive to determining that a human is within a video-based safety zone or an audio-based safety zone associated with a machine among the at least one machine, the workspace configuration application determines whether any human intervention requirement is associated with the machine. In a related embodiment, responsive to identifying at least one human intervention requirement associated with the machine, the workspace configuration application sends a notification to the human directly or facilitates sending a notification to the human via the machine. In a further related embodiment, the notification requests human intervention and includes detail associated with any required human intervention activity. Accordingly, the workspace configuration application presents an intervention opportunity to the human within the video-based safety zone or the audio-based safety zone associated with the machine. In an additional embodiment, the workspace configuration application automatically configures the at least one machine based upon evaluating operating parameters and/or determining human intervention requirements associated with the at least one machine. A method of automatically configuring the at least one machine based upon the at least one human activity datapoint in accordance with step 420 is described with respect to FIG. 13.

FIG. 5 illustrates a method 500 of collecting the workspace activity data in the workspace environment. The method 500 provides one or more embodiments with respect to step 405 of the method 400. The method 500 begins at step 505, where the workspace configuration application calibrates the plurality of video cameras based upon defined object dimensions. In an embodiment, the workspace configuration application calibrates each of the plurality of video cameras based upon dimensions of a predefined object, e.g., a checkerboard. According to such embodiment, the workspace configuration application captures video frames at multiple angles relative to the predefined object, including but not limited to rotation view and translation view. According to such embodiment, the workspace configuration application locates and refines at least one corner of a video frame based upon the dimensions of the predefined object. According to such embodiment, the workspace configuration application calibrates each of the plurality of video cameras based upon captured two-dimensional video frames, including respective locations of the at least one corner and the dimensions of the predefined object within the captured frames. At step 510, the workspace configuration application calibrates the at least one microphone to capture a predefined frequency range encompassing human activity and machine activity in the workspace environment. In an embodiment, the workspace configuration application calibrates the predefined frequency range to capture any human voice originating from human activity and any machine noise originating from machine activity. At step 515, the workspace configuration application removes noise from the plurality of audio segments captured by the at least one microphone. In an embodiment, the workspace configuration application removes noise from one or more of the plurality of audio segments by applying a high-pass filter configured to filter out non-human audio and/or non-machine audio by isolating and amplifying human audio and/or machine audio. In an additional embodiment, the workspace configuration application removes noise from one or more of the plurality of audio segments by applying an autoencoder. In an alternative embodiment, the workspace configuration application executes the steps of the method 500 in an alternative order than the order presented. In a further alternative embodiment, the workspace configuration application executes only a subset of steps of the method 500. In a further alternative embodiment, the workspace configuration application executes multiple steps of the method 500 simultaneously.

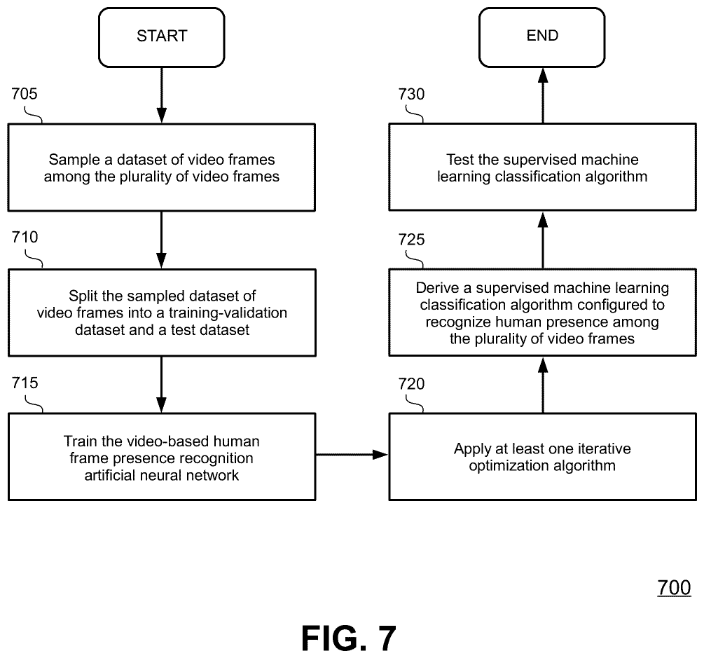

FIG. 6 illustrates a method 600 of configuring the at least one workspace positioning artificial neural network based upon analysis of the workspace activity data. The method 600 provides one or more embodiments with respect to step 410 of the method 400. The method 600 begins at step 605, where the workspace configuration application records video annotations associated with a plurality of objects located within the plurality of video frames. In an embodiment, the workspace configuration application annotates the plurality of objects (e.g., humans, machines, etc.) within the plurality of video frames by capturing dimensional aspects of each of the plurality of objects and assigning a label to each of the plurality of objects. At step 610, the workspace configuration application configures a video-based human frame presence recognition artificial neural network based upon analysis of video annotations among the recorded video annotations that relate to human presence in the workspace environment. Based upon training the video-based human frame presence recognition artificial neural network via video annotation analysis, the workspace configuration application may determine whether a human is present within a video frame. In an embodiment, the workspace configuration application configures the video-based human frame presence recognition artificial neural network by training through cross-validation, which entails splitting the sampled dataset of video frames based upon training, evaluation, and testing. A method of configuring the video-based human frame presence recognition artificial neural network in accordance with step 610 is described with respect to FIG. 7.

FIG. 7 illustrates a method 700 of configuring the video-based human frame presence recognition artificial neural network. The method 700 provides one or more embodiments with respect to step 610 of the method 600. The method 700 begins at step 705, where the workspace configuration application samples a dataset of video frames among the plurality of video frames. At step 710, the workspace configuration application splits the sampled dataset of video frames into a training-validation dataset and a test dataset. In an embodiment, the workspace configuration application splits the sampled dataset of video frames per step 710 randomly, e.g., via application of a randomized algorithm.

At step 715, the workspace configuration application trains the video-based human frame presence recognition artificial neural network via video annotation analysis by splitting the training-validation dataset into a training dataset and a validation dataset according to a cross-validation technique. In an embodiment, training input to the video-based human frame presence recognition artificial neural network includes all or a subset of video annotations recorded in association with the sampled dataset of video frames that relate to human presence. According to step 715, the workspace configuration application cross-validates the video-based human frame presence recognition artificial neural network by splitting sampled video frames in the training-validation dataset into the training dataset and the validation dataset in a predefined number of configurations. In an embodiment, the workspace configuration application cross-validates by splitting the sampled video frames in the training-validation dataset in different ways at various intervals, such that the sampled video frames in the training-validation dataset are applied for both validation and training. The workspace configuration application determines the predefined number of configurations in which the sampled video frames in the training-validation dataset are split into the training dataset and the validation dataset based upon requirements of the cross-validation technique. For instance, given that a cross-validation technique requires x number of configurations, the predefined number of configurations is x. Upon splitting the video frames into a particular configuration, the workspace configuration application completes a cross-validation step for the video-based human frame presence recognition artificial neural network by training the artificial neural network based upon the training dataset and evaluating the artificial neural network based upon the validation dataset, which for purposes of cross-validation is complementary to the training dataset. Based upon such training, the workspace configuration application labels each of the plurality of video frames as being in a class indicative of human presence or in a class indicative of no human presence (i.e., indicative of human absence).

In an embodiment, the video-based human frame presence recognition artificial neural network is a convolutional neural network configured to identify object boundaries within each of the sampled dataset of video frames. According to such embodiment, the workspace configuration application compares the identified object boundaries to image embedding information included in the input video annotations in order to determine whether the identified object boundaries correlate with human characteristics. In an additional embodiment, the workspace configuration application cross-validates the artificial neural network by applying k-fold cross-validation. According to such additional embodiment, the workspace configuration application splits the video frames in the training-validation dataset multiple times into k subsets of data, where all but one of the k subsets of data are included in the training dataset based upon which the artificial neural network is trained and the one subset is reserved as the validation dataset based upon which the artificial neural network is validated. According to such additional embodiment, the workspace configuration application performs the training and evaluation k times, each time reserving a different subset as the validation dataset. K-fold cross-validation is applicable in a scenario in which the sampled dataset of video frames is relatively small, such that identification of object boundaries within video frames requires relatively less data.

At step 720, the workspace configuration application applies at least one iterative optimization algorithm to the training dataset in order to minimize a loss function associated with the video-based human frame presence recognition artificial neural network. According to step 720, the workspace configuration application applies at least one iterative optimization algorithm to the training dataset in order to minimize a loss function (i.e., a cost function) measuring output prediction capability of the artificial neural network. In the context of the various embodiments, the workspace configuration application minimizes a loss function by addressing the loss function in order to reduce artificial neural network output prediction cost as much as possible. In a related embodiment, the at least one iterative optimization algorithm includes at least one gradient descent algorithm. In the context of the various embodiments, a loss function measures output prediction effectiveness on the test dataset. By applying the at least one iterative optimization algorithm, the workspace configuration application determines a set of video-based human frame presence recognition artificial neural network parameters (i.e., weights and biases) in order to minimize the loss function.

At step 725, the workspace configuration application derives a supervised machine learning classification algorithm configured to recognize human presence among the plurality of video frames. According to step 725, the workspace configuration application derives the supervised machine learning classification algorithm consequent to training the video-based human frame presence recognition artificial neural network through cross-validation and consequent to minimizing the loss function. The classification algorithm derived per step 725 is configured to classify a video frame as indicative of human presence or as indicative of no human presence (i.e., indicative of human absence).

At step 730, the workspace configuration application tests the supervised machine learning classification algorithm derived per step 725 via the test dataset. The workspace configuration application tests the supervised machine learning classification algorithm by evaluating for accuracy the classification of video frames of the test dataset with respect to human presence. In an embodiment, the workspace configuration application identifies testing of the test dataset as successful responsive to successful classification of human video frame presence that meets or exceeds a predefined video-based human frame presence recognition testing confidence threshold. In a related embodiment, the predefined video-based human frame presence recognition testing confidence threshold optionally is determined by a user associated with the workspace environment or alternatively is determined by a workspace administrator.

FIG. 8 illustrates a method 800 of configuring the at least one workspace positioning artificial neural network based upon analysis of the workspace activity data. The method 800 provides one or more further embodiments with respect to step 410 of the method 400. The method 800 begins at step 805, where the workspace configuration application defines at least one video-based safety zone around the at least one machine. In an embodiment, the workspace configuration application defines a video-based safety zone of a certain machine among the at least one machine by designating a defined vicinity of the certain machine using lines and/or shapes such as boxes, polygons, ellipses, etc. In a related embodiment, the defined vicinity of a certain machine is indicative of an area in which human presence may cause machine disruption and/or in which human presence is potentially dangerous. In a further related embodiment, the workspace configuration application defines a video-based safety zone of a certain machine among the at least one machine by designating a defined vicinity having dimensions that permit enough time for the certain machine to switch to a safety operation mode upon entry of a human or multiple humans into the video-based safety zone. In an additional embodiment, the at least one video-based safety zone includes at least one aggregated video-based safety zone. An aggregated video-based safety zone pertains to multiple machines among the at least one machine.

At step 810, the workspace configuration application records video annotations associated with a plurality of objects located within the plurality of video frames. In an embodiment, the workspace configuration application annotates the plurality of objects (e.g., humans, machines, etc.) within the plurality of video frames by capturing dimensional aspects of each of the plurality of objects and assigning a label to each of the plurality of objects. In an additional embodiment, the workspace configuration application annotates the plurality of objects relative to the at least one video-based safety zone. In a related embodiment, the workspace configuration application annotates a boundary cross event associated with a human entering a video-based safety zone among the least one video-based safety zone by crossing a boundary of the video-based safety zone to move from not within the zone (i.e., outside the zone) to within the zone (i.e., inside the zone), such that the boundary cross results in the human becoming present within the zone. In a further related embodiment, the workspace configuration application annotates an event associated with a human leaving a video-based safety zone among the least one video-based safety zone by crossing a boundary of the video-based safety zone to move from within the zone to not within the zone, such that the boundary cross results in the human no longer being present within the zone.

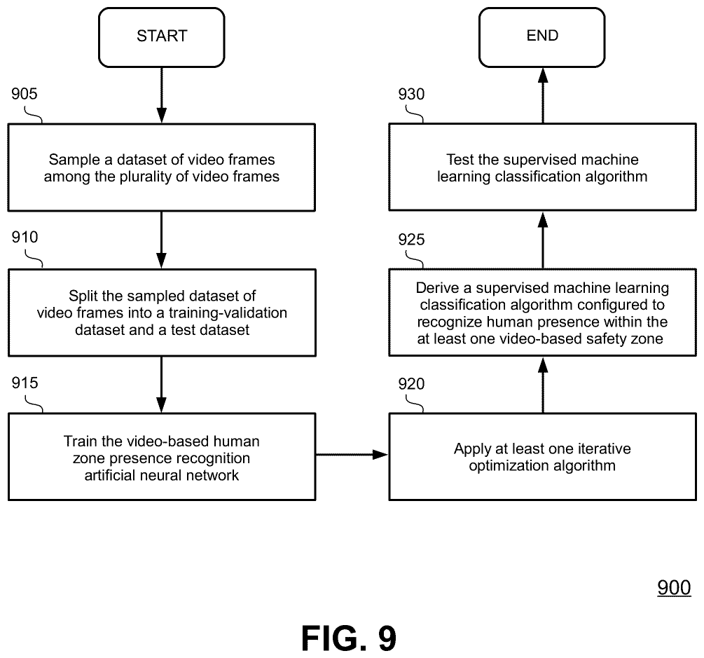

At step 815, the workspace configuration application configures a video-based human zone presence recognition artificial neural network based upon analysis of video annotations among the recorded video annotations that relate to human presence within the at least one video-based safety zone. In an embodiment, the workspace configuration application configures the video-based human zone presence recognition artificial neural network by training through cross-validation. In an additional embodiment, to address a scenario in which multiple video-based safety zones of multiple machines overlap, the workspace configuration application configures the video-based human zone presence recognition artificial neural network to account for multiple video-based safety zones or an aggregated video-based safety zone. A method of configuring the video-based human zone presence recognition artificial neural network in accordance with step 815 is described with respect to FIG. 9.

FIG. 9 illustrates a method 900 of configuring the video-based human zone presence recognition artificial neural network. The method 900 provides one or more embodiments with respect to step 815 of the method 800. The method 900 begins at step 905, where the workspace configuration application samples a dataset of video frames among the plurality of video frames. At step 910, the workspace configuration application splits the sampled dataset of video frames into a training-validation dataset and a test dataset. In an embodiment, the workspace configuration application splits the sampled dataset of video frames per step 910 randomly, e.g., via application of a randomized algorithm.

At step 915, the workspace configuration application trains the video-based human zone presence recognition artificial neural network via video annotation analysis by splitting the training-validation dataset into a training dataset and a validation dataset according to a cross-validation technique. In an embodiment, training input to the video-based human zone presence recognition artificial neural network includes all or a subset of video annotations recorded in association with the sampled dataset of video frames that relate to human presence within the at least one video-based safety zone. According to step 915, the workspace configuration application cross-validates the video-based human zone presence recognition artificial neural network by splitting sampled video frames in the training-validation dataset into the training dataset and the validation dataset in a predefined number of configurations. In an embodiment, the workspace configuration application cross-validates by splitting the sampled video frames in the training-validation dataset in different ways at various intervals, such that the sampled video frames in the training-validation dataset are applied for both validation and training. The workspace configuration application determines the predefined number of configurations in which the sampled video frames in the training-validation dataset are split into the training dataset and the validation dataset based upon requirements of the cross-validation technique. Upon splitting the video frames into a particular configuration, the workspace configuration application completes a cross-validation step for the video-based human zone presence recognition artificial neural network by training the artificial neural network based upon the training dataset and evaluating the artificial neural network based upon the validation dataset. Based upon such training, the workspace configuration application labels each of the plurality of video frames as being in a class indicative of human presence within the at least one video-based safety zone or in a class indicative of no human presence within the at least one video-based safety zone (i.e., indicative of human absence within the at least one video-based safety zone).

In an embodiment, the video-based human zone presence recognition artificial neural network is a convolutional neural network configured to identify object boundaries within each of the sampled dataset of video frames. According to such embodiment, the workspace configuration application compares the identified object boundaries to image embedding information included in the input video annotations in order to determine whether the identified object boundaries correlate with human object boundaries. Responsive to determining that the identified object boundaries correlate with human object boundaries, the workspace configuration application further determines whether the human object boundaries are within one or more of the at least one video-based safety zone. In a further embodiment, the workspace configuration application cross-validates the artificial neural network by applying k-fold cross-validation with respect to video frames in the training-validation dataset.

In an embodiment, the workspace configuration application applies at least one kinematics equation in order to facilitate classification training utilizing the training-validation dataset in the workspace environment. According to such embodiment, the workspace configuration application facilitates determination of human presence within one or more of the video frames in the training-validation dataset by applying at least one kinematics equation to project at least one boundary cross event associated with the at least one video-based safety zone.

At step 920, the workspace configuration application applies at least one iterative optimization algorithm to the training dataset in order to minimize a loss function associated with the video-based human zone presence recognition artificial neural network. The loss function measures output prediction capability of the artificial neural network. In an embodiment, the at least one iterative optimization algorithm includes at least one gradient descent algorithm. By applying the at least one iterative optimization algorithm, the workspace configuration application determines a set of video-based human zone presence recognition artificial neural network parameters (i.e., weights and biases) in order to minimize the loss function.

At step 925, the workspace configuration application derives a supervised machine learning classification algorithm configured to recognize human presence within the at least one video-based safety zone. According to step 925, the workspace configuration application derives the supervised machine learning classification algorithm consequent to training the video-based human zone presence recognition artificial neural network through cross-validation and consequent to minimizing the loss function. The classification algorithm derived per step 925 is configured to classify a video frame as indicative of human presence within the at least one video-based safety zone or as indicative of no human presence within the at least one video-based safety zone (i.e., indicative of human absence within the at least one video-based safety zone). Whereas the classification algorithm derived per the method 700 classifies a video frame based upon human presence within the video frame, i.e., whether a human or multiple humans are detected within the video frame, the classification algorithm derived per the method 900 classifies a video frame based upon human presence within the at least one video-based safety zone.

At step 930, the workspace configuration application tests the supervised machine learning classification algorithm derived per step 925 via the test dataset. The workspace configuration application tests the supervised machine learning classification algorithm by evaluating for accuracy the classification of video frames of the test dataset with respect to human presence within the at least one video-based safety zone. In an embodiment, the workspace configuration application determines testing of the test dataset as successful responsive to successful classification of human zone presence that meets or exceeds a predefined video-based human zone presence recognition testing confidence threshold. In a related embodiment, the predefined video-based human zone presence recognition testing confidence threshold optionally is determined by a user associated with the workspace environment or alternatively is determined by a workspace administrator.

FIG. 10 illustrates a method 1000 of configuring the at least one workspace positioning artificial neural network based upon analysis of the workspace activity data. The method 1000 provides one or more further embodiments with respect to step 410 of the method 400. The method 1000 begins at step 1005, where the workspace configuration application defines at least one audio-based safety zone around the at least one machine. In an embodiment, the workspace configuration application defines an audio-based safety zone of a certain machine among the at least one machine by designating a defined vicinity of the certain machine, e.g., based upon respective sound patterns associated with one or more of the at least one machines. In a related embodiment, the defined vicinity of a certain machine is indicative of an area in which human presence may cause machine disruption and/or in which human presence is potentially dangerous. In a further related embodiment, the workspace configuration application defines an audio-based safety zone of a certain machine among the at least one machine by designating a defined vicinity having dimensions that permit enough time for the certain machine to switch to a safety operation mode upon entry of a human or multiple humans into the audio-based safety zone. In an additional embodiment, the at least one audio-based safety zone includes at least one aggregated audio-based safety zone. An aggregated audio-based safety zone pertains to multiple machines among the at least one machine. At step 1010, the workspace configuration application records audio annotations including time interval information associated with human voice detected in the plurality of audio segments within or within a predefined distance from the at least one audio-based safety zone. In an embodiment, the audio annotations recorded per step 1010 include voice identification indicia to associate respective voice characteristics (e.g., volume, tone, depth, cadence, accent, etc.) with a particular human or group of humans in the workspace environment.

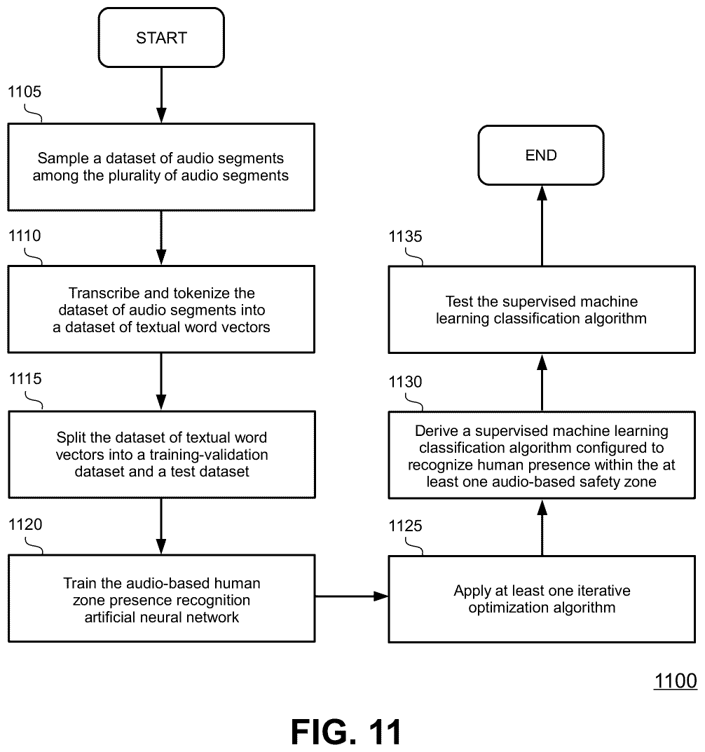

At step 1015, the workspace configuration application configures an audio-based human zone presence recognition artificial neural network based upon analysis of audio annotations among the recorded audio annotations that relate to human presence within the at least one audio-based safety zone. In an embodiment, the workspace configuration application configures the audio-based human zone presence recognition artificial neural network by training through cross-validation. In an additional embodiment, the workspace configuration application analyzes audio annotations among the recorded audio annotations relating to human presence by identifying audio annotations associated with human voice detected within or within the predefined distance from one or more of the at least one audio-based safety zone. According to such additional embodiment, as further described herein the workspace configuration application analyzes textual word vectors corresponding to audio annotations among the recorded audio annotations relating to human presence in the workspace environment relative to the at least one audio-based safety zone. In a further embodiment, to address a scenario in which multiple audio-based safety zones of multiple machines overlap, the workspace configuration application configures the audio-based human zone presence recognition artificial neural network to account for multiple audio-based safety zones or an aggregated audio-based safety zone. A method of configuring the audio-based human zone presence recognition artificial neural network in accordance with step 1015 is described with respect to FIG. 11.

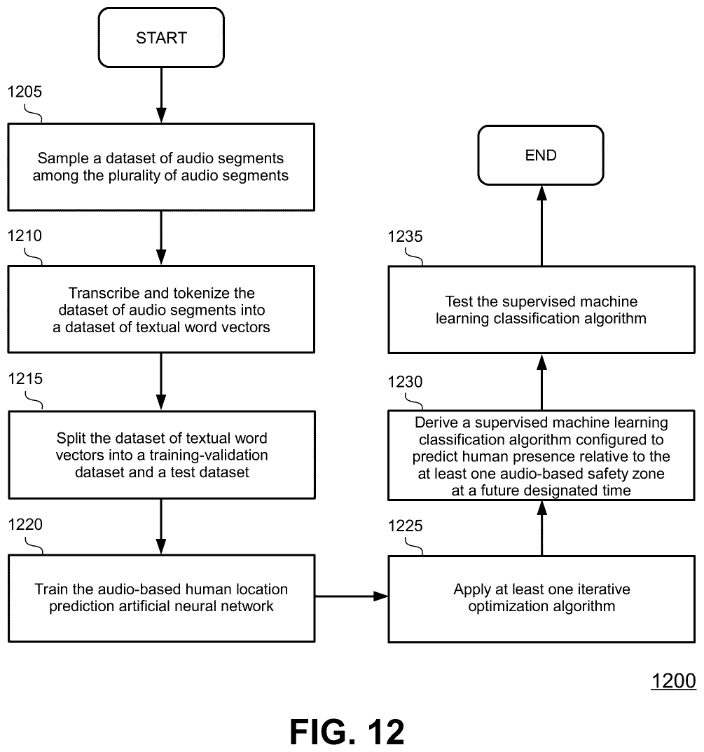

At step 1020, the workspace configuration application configures an audio-based human location prediction artificial neural network based upon analysis of audio annotations among the recorded audio annotations that relate to human location change in the workspace environment relative to the at least one audio-based safety zone. In an embodiment, the workspace configuration application configures the audio-based human location prediction artificial neural network by training through cross-validation. In an additional embodiment, the workspace configuration application analyzes audio annotations among the recorded audio annotations relating to human location change by identifying audio annotations associated with human voice detected within or within the predefined distance from one or more of the at least one audio-based safety zone. According to such additional embodiment, as further described herein the workspace configuration application analyzes textual word vectors corresponding to audio annotations among the recorded audio annotations relating to human location change in the workspace environment relative to the at least one audio-based safety zone. In an additional embodiment, to address a scenario in which multiple audio-based safety zones of multiple machines overlap, the workspace configuration application configures the audio-based human location prediction artificial neural network to account for multiple audio-based safety zones or an aggregated audio-based safety zone. A method of configuring the audio-based human location prediction artificial neural network in accordance with step 1020 is described with respect to FIG. 12.

In an alternative embodiment, the workspace configuration application executes the steps of the method 1000 in an alternative order than the order presented. For instance, the workspace configuration application may execute step 1015 and step 1020 in reverse order. In a further alternative embodiment, the workspace configuration application executes only a subset of steps of the method 1000. For instance, the workspace configuration application may execute step 1015 but not step 1020 or may execute step 1020 but not step 1015. In a further alternative embodiment, the workspace configuration application executes multiple steps of the method 1000, e.g., step 1015 and step 1020, simultaneously.

FIG. 11 illustrates a method 1100 of configuring the audio-based human zone presence recognition artificial neural network. The method 1100 provides one or more embodiments with respect to step 1015 of the method 1000. The method 1100 begins at step 1105, where the workspace configuration application samples a dataset of audio segments among the plurality of audio segments. At step 1110, the workspace configuration application transcribes and tokenizes the dataset of audio segments into a dataset of textual word vectors. Per step 1110, the workspace configuration application transcribes each audio segment in the dataset of audio segments into text. In an embodiment, workspace configuration application transcribes each audio segment by applying at least one natural language processing (NLP) algorithm. In a related embodiment, the at least one NLP algorithm includes a speech recognition algorithm, e.g., at least one speech-to-text algorithm. Furthermore, per step 1110 the workspace configuration application tokenizes each transcribed audio segment into a sequence of word units, with each word unit including a word or group of words, and vectorizes each word unit of the sequence of word units into a textual word vector. Dependent on contextual relations among the words in the sequence of word units, the workspace configuration application vectorizes a single word into a single word vector or alternatively vectorizes a group of words into a single word vector. In an embodiment, the workspace configuration application eliminates from consideration any textual word vector having a confidence score below a predefined vector confidence level threshold with respect to origin of the textual word vector within one or more of the at least one audio-based safety zone. At step 1115, the workspace configuration application splits the dataset of textual word vectors into a training-validation dataset and a test dataset. In an embodiment, the workspace configuration application splits the dataset of textual word vectors per step 1115 randomly, e.g., via application of a randomized algorithm.

At step 1120, the workspace configuration application trains the audio-based human zone presence recognition artificial neural network via audio annotation analysis by splitting the training-validation dataset into a training dataset and a validation dataset according to a cross-validation technique. In an embodiment, training input to the audio-based human zone presence recognition artificial neural network includes audio annotations relating to human voice detected within or within the predefined distance from one or more of the at least one audio-based safety zone. According to step 1120, the workspace configuration application cross-validates the audio-based human zone presence recognition artificial neural network by splitting textual word vectors in the training-validation dataset into the training dataset and the validation dataset in a predefined number of configurations. In an embodiment, the workspace configuration application cross-validates by splitting the textual word vectors in the training-validation dataset in different ways at various intervals, such that the textual word vectors are applied for both validation and training. The workspace configuration application determines the predefined number of configurations in which the textual word vectors in the training-validation dataset are split into the training dataset and the validation dataset based upon requirements of the cross-validation technique. Upon splitting the textual word vectors into a particular configuration, the workspace configuration application completes a cross-validation step for the artificial neural network by training the artificial neural network based upon the training dataset and evaluating the artificial neural network based upon the validation dataset. Based upon such training, the workspace configuration application labels each of the dataset of textual word vectors transcribed and tokenized from the dataset of audio segments as being in a class indicative of human presence within the at least one audio-based safety zone or in a class indicative of no human presence within the at least one audio-based safety zone (i.e., indicative of human absence within the at least one audio-based safety zone).

In an embodiment, the audio-based human zone presence recognition artificial neural network is a recurrent neural network configured to analyze textual word vectors in view of audio annotations among the recorded audio annotations associated with human presence relative to at least one audio-based safety zone. In a related embodiment, the workspace configuration application identifies human language patterns of textual word vectors in the training-validation dataset associated with human voice detected within or within the predefined distance from one or more of the at least one audio-based safety zone and derives human presence datapoints based upon the identified human language patterns. In an additional related embodiment, the workspace configuration application determines whether a human presence datapoint is within one or more of the at least one audio-based safety zone. In a further related embodiment, the workspace configuration application trains the artificial neural network in conjunction with a long short-term memory recurrent neural network (LSTM-RNN) architecture configured to store at least one time series pattern associated with the dataset of textual word vectors. According to such further related embodiment, the workspace configuration application determines human presence relative to the at least one audio-based safety zone based at least in part upon the at least one time series pattern. In an additional embodiment, the workspace configuration application cross-validates the artificial neural network by applying k-fold cross-validation with respect to textual word vectors in the training-validation dataset. K-fold cross-validation is applicable in a scenario in which the dataset of textual word vectors is relatively small, such that identification of audio characteristics (e.g., human presence datapoints) associated with textual word vectors requires relatively less data.

At step 1125, the workspace configuration application applies at least one iterative optimization algorithm to the training dataset in order to minimize a loss function associated with the audio-based human zone presence recognition artificial neural network. The loss function measures output prediction capability of the artificial neural network. In an embodiment, the at least one iterative optimization algorithm includes at least one gradient descent algorithm. By applying the at least one iterative optimization algorithm, the workspace configuration application determines a set of audio-based human zone presence recognition artificial neural network parameters (i.e., weights and biases) in order to minimize the loss function.

At step 1130, the workspace configuration application derives a supervised machine learning classification algorithm configured to recognize human presence within the at least one audio-based safety zone. According to step 1130, the workspace configuration application derives the supervised machine learning classification algorithm consequent to training the audio-based human zone presence recognition artificial neural network through cross-validation and consequent to minimizing the loss function. By deriving human presence datapoints in the context of training per step 1120, the workspace configuration application is configured to derive the supervised machine learning classification algorithm according to step 1130 that is capable of determining human presence relative to the at least one audio-based safety zone. The classification algorithm derived per step 1130 is configured to classify a textual word vector as indicative of human presence within the at least one audio-based safety zone or as indicative of no human presence within the at least one audio-based safety zone (i.e., indicative of human absence within the at least one audio-based safety zone).

At step 1135, the workspace configuration application tests the supervised machine learning classification algorithm derived per step 1130 via the test dataset. The workspace configuration application tests the supervised machine learning classification algorithm by evaluating for accuracy the classification of textual word vectors of the test dataset with respect to human presence relative to the at least one audio-based safety zone. In an embodiment, the workspace configuration application determines testing of the test dataset as successful responsive to successful classification of human zone presence that meets or exceeds a predefined audio-based human zone presence recognition testing confidence threshold. In a related embodiment, the predefined audio-based human zone presence recognition testing confidence threshold optionally is determined by a user associated with the workspace environment or alternatively is determined by a workspace administrator.

FIG. 12 illustrates a method 1200 of configuring the audio-based human location prediction artificial neural network. The method 1200 provides one or more embodiments with respect to step 1020 of the method 1000. The method 1200 begins at step 1205, where the workspace configuration application samples a dataset of audio segments among the plurality of audio segments. At step 1210, the workspace configuration application transcribes and tokenizes the dataset of audio segments into a dataset of textual word vectors. Per step 1210, the workspace configuration application transcribes and tokenizes the dataset of audio segments into the dataset of textual word vectors in accordance with embodiments identical or analogous to the embodiments described with respect to step 1110 of the method 1100. At step 1215, the workspace configuration application splits the dataset of textual word vectors into a training-validation dataset and a test dataset. In an embodiment, the workspace configuration application splits the dataset of textual word vectors per step 1215 randomly, e.g., via application of a randomized algorithm.

At step 1220, the workspace configuration application trains the audio-based human location prediction artificial neural network via audio annotation analysis by splitting the training-validation dataset into a training dataset and a validation dataset according to a cross-validation technique. In an embodiment, training input to the recurrent neural network includes audio annotations relating to human voice detected within or within the predefined distance from one or more of the at least one audio-based safety zone. According to step 1220, the workspace configuration application cross-validates the audio-based human location prediction artificial neural network by splitting textual word vectors in the training-validation dataset into the training dataset and the validation dataset in a predefined number of configurations. In an embodiment, the workspace configuration application cross-validates by splitting the textual word vectors in the training-validation dataset in different ways at various intervals, such that the textual word vectors are applied for both validation and training. The workspace configuration application determines the predefined number of configurations in which the textual word vectors in the training-validation dataset are split into the training dataset and the validation dataset based upon requirements of the cross-validation technique. Upon splitting the textual word vectors into a particular configuration, the workspace configuration application completes a cross-validation step for the artificial neural network by training the artificial neural network based upon the training dataset and evaluating the artificial neural network based upon the validation dataset. Based upon such training, the workspace configuration application labels each of the dataset of textual word vectors transcribed and tokenized from the dataset of audio segments as being in a class indicating human presence inside the at least one audio-based safety zone (i.e., human presence within the at least one audio-based safety zone) at a future designated time (e.g., at x minutes and y seconds from present time) or in a class indicating human presence outside the at least one audio-based safety zone (i.e., no human presence within the at least one audio-based safety zone) at the future designated time.

In an embodiment, the audio-based human location prediction artificial neural network is a recurrent neural network configured to analyze textual word vectors in view of audio annotations among the recorded audio annotations relating to human location change in association with at least one audio-based safety zone. According to such embodiment, the workspace configuration application identifies human language patterns associated with textual word vectors in the training-validation dataset associated with human voice detected within or within the predefined distance from one or more of the at least one audio-based safety zone and derives human location change datapoints based upon the identified human language patterns. In a related embodiment, the workspace configuration application derives projected human traversal path datapoints corresponding to respective locations with the workspace environment based upon the derived human location change datapoints. In an additional related embodiment, the workspace configuration application determines whether a projected human traversal path datapoint corresponding to a respective location in the workspace environment is within one or more of the at least one audio-based safety zone. In a further related embodiment, the workspace configuration application trains the artificial neural network in conjunction with a LSTM-RNN architecture configured to store at least one time series pattern associated with the dataset of textual word vectors. In a further related embodiment, the workspace configuration application derives the at least one time series pattern based upon analysis of the derived human location change datapoints. According to such further related embodiment, the workspace configuration application derives the projected human traversal path datapoints and/or predicts other human location change aspects relative to the at least one audio-based safety zone based at least in part upon the derived at least one time series pattern. In an additional embodiment, the workspace configuration application cross-validates the artificial neural network by applying k-fold cross-validation with respect to textual word vectors in the training-validation dataset.

At step 1225, the workspace configuration application applies at least one iterative optimization algorithm to the training dataset in order to minimize a loss function associated with the audio-based human location prediction artificial neural network. The loss function measures output prediction capability of the artificial neural network. In an embodiment, the at least one iterative optimization algorithm includes at least one gradient descent algorithm. By applying the at least one iterative optimization algorithm, the workspace configuration application determines a set of audio-based human location prediction artificial neural network parameters (i.e., weights and biases) in order to minimize the loss function.

At step 1230, the workspace configuration application derives a supervised machine learning classification algorithm configured to predict human presence relative to the at least one audio-based safety zone at a future designated time. According to step 1230, the workspace configuration application derives the supervised machine learning classification algorithm consequent to training the audio-based human location prediction artificial neural network through cross-validation and consequent to minimizing the loss function. By deriving projected human traversal path datapoints corresponding to respective locations with the workspace environment based upon the human location change datapoints in the context of training per step 1220, the workspace configuration application is configured to derive the supervised machine learning classification algorithm according to step 1230 that is capable of predicting human presence relative to the at least one audio-based safety zone. The classification algorithm derived per step 1230 is configured to classify a textual word vector as indicative of human presence inside the at least one audio-based safety zone at the future designated time or as indicative of human presence outside the at least one audio-based safety zone at the future designated time.

At step 1235, the workspace configuration application tests the supervised machine learning classification algorithm derived per step 1230 via the test dataset. The workspace configuration application tests the supervised machine learning classification algorithm by evaluating for accuracy the classification of textual word vectors of the test dataset with respect to human presence prediction relative to the at least one audio-based safety zone at the future designated time. In an embodiment, the workspace configuration application determines testing of the test dataset as successful responsive to successful classification of human presence prediction that meets or exceeds a predefined audio-based human location prediction testing confidence threshold. In a related embodiment, the predefined audio-based human location prediction testing confidence threshold optionally is determined by a user associated with the workspace environment or alternatively is determined by a workspace administrator.

FIG. 13 illustrates a method 1300 of automatically configuring the at least one machine based upon the at least one human activity datapoint. The method 1300 provides one or more embodiments with respect to step 420 of the method 400. The method 1300 begins at step 1305, where the workspace configuration application evaluates operating parameters associated with the at least one machine. In an embodiment, based upon the at least one human activity datapoint, the workspace configuration application determines a standard value range of operation for each operating parameter associated with each machine among the at least one machine. In a related embodiment, the workspace configuration application identifies an operating parameter value outside a standard value range of operation determined for the operating parameter as a dangerous operating parameter. In an additional embodiment, the workspace configuration application identifies parameters associated with a safety operation mode for each machine among the at least one machines. The safety operation mode incorporates a safe value range of operation more stringent than the standard value range of operation for at least one operating parameter associated with each machine to account for human presence within the video-based safety zone or the audio-based safety zone associated with the machine. In a further embodiment, based upon the at least one human activity datapoint, the workspace configuration application identifies correlations between respective operating parameters associated with one or more of the at least one machine and activities performed in the workspace environment. Based upon such identified correlations, the workspace configuration application determines any operating parameter associated with one or more of the at least one machine required to perform a certain activity in the workspace environment. In a further embodiment, based upon the at least one human activity datapoint and/or the workspace activity data, the workspace configuration application determines a duration of time required to perform a certain activity associated with one or more of the at least one machine.

At step 1310, the workspace configuration application determines human intervention requirements associated with the at least one machine. In an embodiment, based upon the at least one human activity datapoint and/or the workspace activity data (e.g., historical data associated with workspace activity and human presence in the workspace environment), the workspace configuration application determines whether human intervention is required to perform a certain activity associated with one or more of the at least one machine. In a related embodiment, responsive to determining that human intervention is required to perform the certain activity, the workspace configuration application determines a duration of human intervention required and characteristics of such human intervention. In a related embodiment, human intervention includes application of human technical expertise and/or human analytical expertise. In a further related embodiment, the workspace configuration application determines when human intervention is required based upon the at least one human activity datapoint and/or the workspace activity data, e.g., based upon at least one machine activity feed obtained or received from one or more of the at least one machine and/or based upon video frames or audio segments. According to such further related embodiment, the workspace configuration application determines a range of operating parameters associated with one or more of the at least one machine for which human intervention is required. For instance, given a machine including a rotating apparatus, the workspace configuration application may determine that human intervention is required when rotation velocity of the rotating apparatus is above a predefined threshold rotation velocity or within a predefined rotation velocity range. In another instance, given a machine including a vibrating apparatus, the workspace configuration application may determine that human intervention is required when vibration velocity of the vibrating apparatus is above a predefined threshold vibration velocity or within a predefined vibration velocity range. In an alternative embodiment, the workspace configuration application executes the steps of the method 1300 in reverse order. In a further alternative embodiment, the workspace configuration application executes the steps of the method 1300 simultaneously.

The descriptions of the various embodiments have been presented for purposes of illustration but are not intended to be exhaustive or limited to the embodiments disclosed. All kinds of modifications made to the described embodiments and equivalent arrangements should fall within the protected scope of the various embodiments. Hence, the scope should be explained most widely according to the claims that follow in connection with the detailed description and should cover all possibly equivalent variations and equivalent arrangements. Many modifications and variations will be apparent to those of ordinary skill in the art without departing from the scope and spirit of the described embodiments. The terminology used herein is chosen to best explain the principles of the various embodiments, the practical application or technical improvement over technologies found in the marketplace, or to enable others of ordinary skill in the art to understand the various embodiments.

What is claimed is:

1. A computer-implemented method comprising:
collecting workspace activity data in a workspace environment including at least one machine, wherein the workspace activity data is collected at least in part via a plurality of video frames captured by a plurality of video cameras and via a plurality of audio segments captured by at least one microphone;
configuring at least one workspace positioning artificial neural network based upon analysis of the workspace activity data;
applying the at least one workspace positioning artificial neural network to derive at least one human activity datapoint in the workspace environment; and
automatically configuring the at least one machine based upon the at least one human activity datapoint.

2. The computer-implemented method of claim 1, wherein collecting the workspace activity data comprises:
calibrating the plurality of video cameras based upon defined object dimensions.

3. The computer-implemented method of claim 1, wherein collecting the workspace activity data comprises:
calibrating the at least one microphone to capture a predefined frequency range encompassing human activity and machine activity in the workspace environment; and
removing noise from the plurality of audio segments captured by the at least one microphone.

4. The computer-implemented method of claim 1, wherein configuring the at least one workspace positioning artificial neural network comprises:
recording video annotations associated with a plurality of objects located within the plurality of video frames; and
configuring a video-based human frame presence recognition artificial neural network based upon analysis of video annotations among the recorded video annotations that relate to human presence in the workspace environment.

5. The computer-implemented method of claim 4, wherein configuring the video-based human frame presence recognition artificial neural network comprises:
sampling a dataset of video frames among the plurality of video frames;
splitting the sampled dataset of video frames into a training-validation dataset and a test dataset;
training the video-based human frame presence recognition artificial neural network via video annotation analysis by splitting the training-validation dataset into a training dataset and a validation dataset according to a cross-validation technique;
applying at least one iterative optimization algorithm to the training dataset in order to minimize a loss function associated with the video-based human frame presence recognition artificial neural network;
deriving a supervised machine learning classification algorithm configured to recognize human presence among the plurality of video frames; and
testing the supervised machine learning classification algorithm via the test dataset.

6. The computer-implemented method of claim 1, wherein configuring the at least one workspace positioning artificial neural network comprises:
defining at least one video-based safety zone around the at least one machine;
recording video annotations associated with a plurality of objects located within the plurality of video frames; and
configuring a video-based human zone presence recognition artificial neural network based upon analysis of video annotations among the recorded video annotations that relate to human presence within the at least one video-based safety zone.

7. The computer-implemented method of claim 6, wherein configuring the video-based human zone presence recognition artificial neural network comprises:
sampling a dataset of video frames among the plurality of video frames;
splitting the sampled dataset of video frames into a training-validation dataset and a test dataset;
training the video-based human zone presence recognition artificial neural network via video annotation analysis by splitting the training-validation dataset into a training dataset and a validation dataset according to a cross-validation technique;
applying at least one iterative optimization algorithm to the training dataset in order to minimize a loss function associated with the video-based human zone presence recognition artificial neural network;
deriving a supervised machine learning classification algorithm configured to recognize human presence within the at least one video-based safety zone; and
testing the supervised machine learning classification algorithm via the test dataset.

8. The computer-implemented method of claim 1, wherein configuring the at least one workspace positioning artificial neural network comprises:
defining at least one audio-based safety zone around the at least one machine;
recording audio annotations including time interval information associated with human voice detected in the plurality of audio segments within or within a predefined distance from the at least one audio-based safety zone;
configuring an audio-based human zone presence recognition artificial neural network based upon analysis of audio annotations among the recorded audio annotations that relate to human presence within the at least one audio-based safety zone; and
configuring an audio-based human location prediction artificial neural network based upon analysis of audio annotations among the recorded audio annotations that relate to human location change in the workspace environment relative to the at least one audio-based safety zone.

9. The computer-implemented method of claim 8, wherein configuring the audio-based human zone presence recognition artificial neural network comprises:
sampling a dataset of audio segments among the plurality of audio segments;
transcribing and tokenizing the dataset of audio segments into a dataset of textual word vectors;
splitting the dataset of textual word vectors into a training-validation dataset and a test dataset;
training the audio-based human zone presence recognition artificial neural network via audio annotation analysis by splitting the training-validation dataset into a training dataset and a validation dataset according to a cross-validation technique;
applying at least one iterative optimization algorithm to the training dataset in order to minimize a loss function associated with the audio-based human zone presence recognition artificial neural network;
deriving a supervised machine learning classification algorithm configured to recognize human presence within the at least one audio-based safety zone; and
testing the supervised machine learning classification algorithm via the test dataset.

10. The computer-implemented method of claim 8, wherein configuring the audio-based human location prediction artificial neural network comprises:
sampling a dataset of audio segments among the plurality of audio segments;
transcribing and tokenizing the dataset of audio segments into a dataset of textual word vectors;
splitting the dataset of textual word vectors into a training-validation dataset and a test dataset;
training the audio-based human location prediction artificial neural network via audio annotation analysis by splitting the training-validation dataset into a training dataset and a validation dataset according to a cross-validation technique;
applying at least one iterative optimization algorithm to the training dataset in order to minimize a loss function associated with the audio-based human location prediction artificial neural network;
deriving a supervised machine learning classification algorithm configured to predict human presence relative to the at least one audio-based safety zone at a future designated time; and
testing the supervised machine learning classification algorithm via the test dataset.

11. The computer-implemented method of claim 1, wherein automatically configuring the at least one machine based upon the at least one human activity datapoint comprises:
evaluating operating parameters associated with the at least one machine.

12. The computer-implemented method of claim 1, wherein automatically configuring the at least one machine based upon the at least one human activity datapoint comprises:
determining human intervention requirements associated with the at least one machine.

13. A computer program product comprising a computer readable storage medium having program instructions embodied therewith, the program instructions executable by a computing device to cause the computing device to:
collect workspace activity data in a workspace environment including at least one machine, wherein the workspace activity data is collected at least in part via a plurality of video frames captured by a plurality of video cameras and via a plurality of audio segments captured by at least one microphone;
configure at least one workspace positioning artificial neural network based upon analysis of the workspace activity data;
apply the at least one workspace positioning artificial neural network to derive at least one human activity datapoint in the workspace environment; and
automatically configure the at least one machine based upon the at least one human activity datapoint.

14. The computer program product of claim 13, wherein configuring the at least one workspace positioning artificial neural network comprises:
recording video annotations associated with a plurality of objects located within the plurality of video frames; and
configuring a video-based human frame presence recognition artificial neural network based upon analysis of video annotations among the recorded video annotations that relate to human presence in the workspace environment.

15. The computer program product of claim 13, wherein configuring the at least one workspace positioning artificial neural network comprises:
defining at least one video-based safety zone around the at least one machine;
recording video annotations associated with a plurality of objects located within the plurality of video frames; and
configuring a video-based human zone presence recognition artificial neural network based upon analysis of video annotations among the recorded video annotations that relate to human presence within the at least one video-based safety zone.

16. The computer program product of claim 13, wherein configuring the at least one workspace positioning artificial neural network comprises:
defining at least one audio-based safety zone around the at least one machine;
recording audio annotations including time interval information associated with human voice detected in the plurality of audio segments within or within a predefined distance from the at least one audio-based safety zone;
configuring an audio-based human zone presence recognition artificial neural network based upon analysis of audio annotations among the recorded audio annotations that relate to human presence within the at least one audio-based safety zone; and
configuring an audio-based human location prediction artificial neural network based upon analysis of audio annotations among the recorded audio annotations that relate to human location change in the workspace environment relative to the at least one audio-based safety zone.

17. A system comprising:
at least one processor; and
a memory storing an application program, which, when executed on the at least one processor, performs an operation comprising:
collecting workspace activity data in a workspace environment including at least one machine, wherein the workspace activity data is collected at least in part via a plurality of video frames captured by a plurality of video cameras and via a plurality of audio segments captured by at least one microphone;
configuring at least one workspace positioning artificial neural network based upon analysis of the workspace activity data;
applying the at least one workspace positioning artificial neural network to derive at least one human activity datapoint in the workspace environment; and
automatically configuring the at least one machine based upon the at least one human activity datapoint.

18. The system of claim 17, wherein configuring the at least one workspace positioning artificial neural network comprises:
recording video annotations associated with a plurality of objects located within the plurality of video frames; and
configuring a video-based human frame presence recognition artificial neural network based upon analysis of video annotations among the recorded video annotations that relate to human presence in the workspace environment.

19. The system of claim 17, wherein configuring the at least one workspace positioning artificial neural network comprises:
defining at least one video-based safety zone around the at least one machine;
recording video annotations associated with a plurality of objects located within the plurality of video frames; and
configuring a video-based human zone presence recognition artificial neural network based upon analysis of video annotations among the recorded video annotations that relate to human presence within the at least one video-based safety zone.

20. The system of claim 17, wherein configuring the at least one workspace positioning artificial neural network comprises:
defining at least one audio-based safety zone around the at least one machine;
recording audio annotations including time interval information associated with human voice detected in the plurality of audio segments within or within a predefined distance from the at least one audio-based safety zone;
configuring an audio-based human zone presence recognition artificial neural network based upon analysis of audio annotations among the recorded audio annotations that relate to human presence within the at least one audio-based safety zone; and
configuring an audio-based human location prediction artificial neural network based upon analysis of audio annotations among the recorded audio annotations that relate to human location change in the workspace environment relative to the at least one audio-based safety zone.
